(19) United States
(12) Patent Application Publication
(10) Pub. No.: US 2025/0345866 A1
(43) Pub. Date: Nov. 13, 2025

(54) MULTI-FUNCTION BEVELING AND WELD BEAD REMOVAL TOOL

(71) Applicant: Philip HECK, HIGHLAND, MI (US)

(72) Inventor: Philip HECK, HIGHLAND, MI (US)

(21) Appl. No.: 18/657,108

(22) Filed: May 7, 2024

(51) Int. Cl. B23C 3/12; B23K 37/08; B23Q 9/00

(52) U.S. Cl. CPC B23C 3/12; B23K 37/08; B23Q 9/0035

(57) ABSTRACT

A beveling and weld bead removal tool includes a spindle, a cutting wheel mounted on the spindle; a hood configured to receive the cutting wheel therein; and an interchangeable guide adjustably attached to the hood. An outside support bearing provided on the spindle housed within the hood. The interchangeable guide includes one of a flat guide and a V-block guide, each having a pair of plates arranged together side by side and end caps arranged at an end portions of the pair of plates. An opening is formed between the pair of plates that selectively allow a protrusion of the cutting wheel. The flat guide has the plates arranged parallel to each other, and the V-block guide has the plates arranged at an angle to each other. A depth of a cut is adjusted by selectively positioning and securing the end caps on machined slots formed on the hood.

### BACKGROUND OF THE INVENTION

### 1. Field of the Invention

The present invention relates to a multi-function beveling and weld bead removal tool that creates a bevel and removes weld bead from weld joints of welded metal workpieces. More particularly, the present invention relates to a portable multi-function beveling and weld bead removal tool which incorporates an interchangeable guide that allows the ability to create a bevel and remove a weld bead in a single tool, and in which depth of cuts can easily be adjusted by simply sliding the interchangeable guide on a hood of the beveling and weld bead removal tool.

### 2. Description of the Background Art

A number of different tools are known for beveling and weld bead removal. Examples of some of the known tools include those described in U.S. Pat. Nos. 5,423,642, 6,042,311, 6,450,741, 7,070,371, 7,140,816 and 7,251,874.

Although the known beveling and weld removal tools are useful for their intended purposes, a need still exists in the art for an improved multi-function beveling and weld bead removal tool that can create a bevel and remove weld bead from weld joints of welded metal workpieces. In particular, there is a need for an improved beveling and weld bead removal tool which incorporates a convertible, interchangeable guide that allows the ability to create a bevel and remove a weld bead in a single tool. In such beveling tool that creates bevel and removes a weld bid, a depth of cut can easily be adjusted by securing a desired position of the interchangeable guide.

### SUMMARY OF THE INVENTION

The present invention according a first aspect thereof provides portable beveling and weld bead removal tool (also referred to as ‘beveling tool,’ and/or ‘weld bead removal tool’) configured for use with a rotary driver having a drive shaft. The beveling and weld bead removal tool includes a spindle having a first end and a second end, the first end being attachable to the drive shaft of the rotary driver; a cutting wheel (cutter) mounted on the spindle; a hood configured to receive the cutting wheel therein; and a guide adjustably attached to the hood. The guide is selectively positionable on the hood is a direction substantially transverse to an axis the spindle.

The present invention according to a second aspect thereof is characterized in that the guide includes a pair of plates arranged together side by side; and an end cap arranged at each end portion of the pair of plates. An opening is formed between the pair of plates that is configured to selectively allow a protrusion of the cutting wheel for beveling and weld bead removal.

The present invention according to another aspect thereof is characterized in that the end cap has an elongated slot formed therein, the hood has a machined slot including at least one engagement hole formed therein, and the guide is selectively positioned on the hood by a hand knob placed in the elongated slot and engagement hole of the machined slot.

The present invention according to another aspect thereof is characterized in that the plates are arranged parallel to each other thereby forming a flat guide.

The present invention according to another aspect thereof is characterized in that the plates are arranged at an angle to each other thereby forming a V-block guide.

The present invention according to another aspect thereof is characterized in that a pipe roller is mounted on one of the plates of the V-block guide.

For a more complete understanding of the present invention, the reader is referred to the following detailed description section, which should be read in conjunction with the accompanying drawings. Throughout the following detailed description and in the drawings, like numbers refer to like parts.

### BRIEF DESCRIPTION OF THE DRAWINGS

FIG. 1 is an exploded perspective view of a beveling and weld bead removal tool according to an illustrative embodiment of the present invention.

FIG. 2 is an assembled perspective view of the beveling and weld bead removal tool and rotary drive mechanism of FIG. 1.

FIG. 3 is a perspective view of a hood of the beveling and weld bead removal tool.

FIG. 4 is a perspective of a handle that is attachable to the hood.

FIG. 5 is a perspective view of a V-block guide of the beveling and weld bead removal tool.

FIG. 6 is a perspective view of a flat guide of the beveling and weld bead removal tool.

### DETAILED DESCRIPTION

It should be understood that only structures and methodology needed for illustrating selected embodiments of the present invention are described herein. Other conventional structures, and those of ancillary and auxiliary components of the system, will be known and understood by those in the art.

The beveling and weld bead removal tool 10 discussed herein is configured to perform multiple functions, including beveling steel plates for weld preparation; deburring/chamfering steel and cutting slag removal; weld bead removal; and clad removal. The beveling tool 10 features an interchangeable guide for either creating a bevel on a flat plate, rounds and pipe. Another function of the beveling tool is weld bead removal for butt welds, where two plates are welded together side by side and the weld bead needs to be removed flush without damaging the surrounding area as can be seen using a conventional grinder with an abrasive disc. The beveling and weld bead removal tool of the present invention is configured for use with a known, commercially available rotary driver.

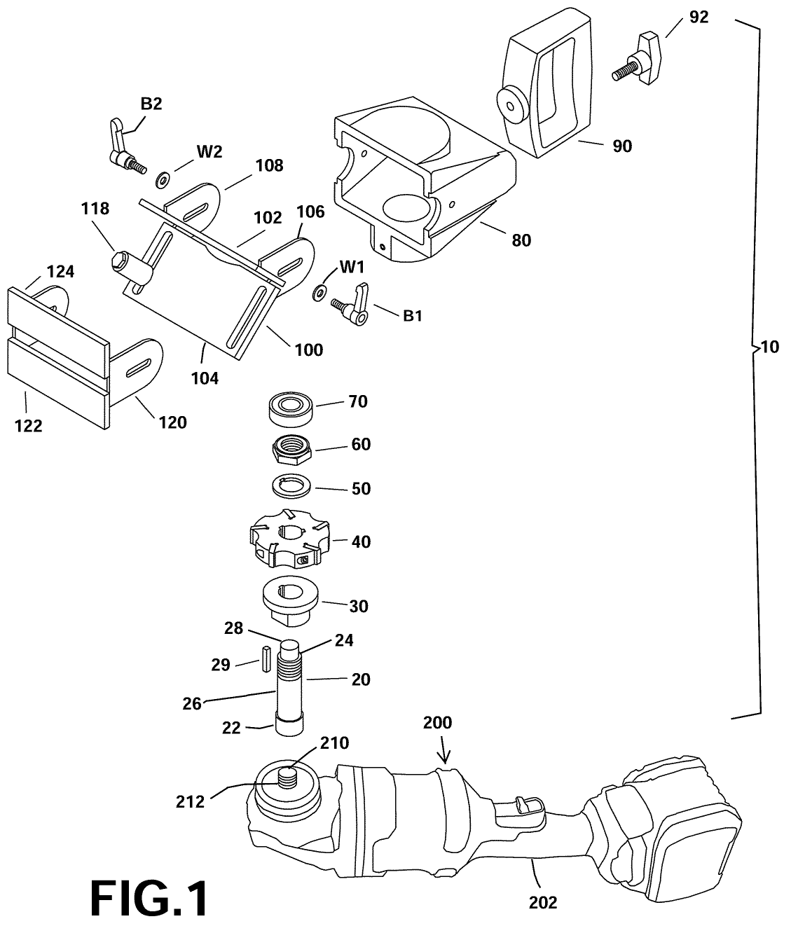

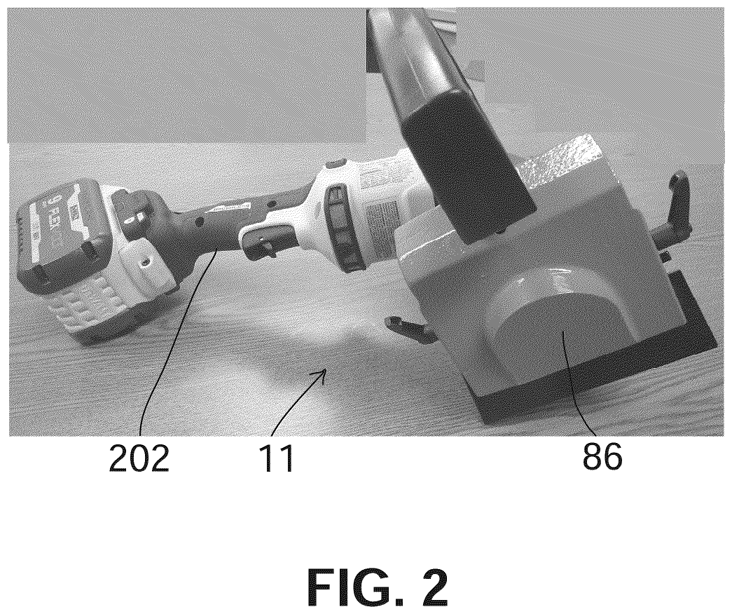

Referring now to the drawings, FIG. 1 is an exploded perspective view of a multi-function beveling and weld bead removal tool 10 (also referred to as a beveling tool and/or weld bead removal tool) according to an illustrative embodiment of the present invention. The beveling tool 10 hereof is configured for use with a known mechanism, such as a rotary driver 200. The rotary driver 200 is a portable device. The rotary driver 200 may either be electrically or pneumatically actuated. A cordless battery may be used to provide a power for operating the rotary driver 200. The rotary driver 200 having the tool 10 mounted thereon as shown in FIG. 2 may be is referred to herein, in combination, as a beveling and weld bead removal machine 11.

The rotary driver 200 includes a graspable main body portion 202. The rotary driver 200 further includes a rotatable drive shaft 210 extending outwardly at an end thereof, in a direction transverse to a longitudinal axis of the main body portion 202. The rotatable drive shaft 210 has a threaded portion 212 formed thereon. The threaded portion 212 may be replaced with a suitable coupling arrangement.

Throughout the following description, the term “proximal” will be used to refer to parts of the beveling and weld bead removal tool 10 which are situated relatively close to the rotary driver 200 in an assembled operational configuration as shown in FIG. 1, and the term “distal” will be used to refer to parts of the beveling and weld bead removal tool 10 which are situated further away from the rotary driver 200 than corresponding proximal parts.

As seen in FIG. 1, the beveling and weld bead removal tool 10 includes a spindle 20 (also referred to as a cylindrical torque transmission shaft or a cutter shaft) with a first (proximal) end 22 having a first threaded bore formed therein for coupling with the threaded drive shaft 210 of the rotary driver 200 by threading. Other suitable coupling arrangements can be made between the spindle 20 and the drive shaft 210. The torque transmission shaft 20 has a second (distal) end 24 and a midsection 26 formed between the first end 22 and the second end 24.

The beveling and weld bead removal tool 10 further includes a spacer 30, a cutting wheel 40, a shim 50, a nut 60, an outside bearing 70, a hood 80, a handle 90, and an interchangeable guide 100, 120. A key 29 is also included.

The rotary driver (motor drive assembly) 200 is fixed/bolted to the hood 80 in a secured manner. The hood 80 is a cast aluminum frame. The hood 80 may be made of other suitable materials.

The spindle 20 is secured onto the drive shaft 210 of the rotary driver 200 by threading the proximal end 22 of the spindle 20 on the threaded portion 212 of the drive shaft 210. The distal end 24 of the spindle 20 is inserted in the hood 80. The distal end 24 included a threaded portion 25 having threads formed thereon and a bearing receiving portion 28. The bearing receiving portion 28 is without threads formed thereon. Further, the spacer 30, the cutting wheel 40, the shim 40, the nut 60 and the outside bearing 70 are assembled onto the spindle 20 in this order in the hood 80. The nut 60 is threaded on a distal end threaded portion 25 for securing the cutting wheel 40 onto the spindle 20 between the spacer 30 and shim 50. The outside bearing 70 is arranged onto the bearing receiving portion 28 of the spindle 20. The outside bearing 70 is securely situated inside a dome portion 86 of the hood 80.

As noted above, the hood 80 of the beveling and weld bead removal tool 10 securely houses the cutting wheel 40 therein.

### Hood Assembly

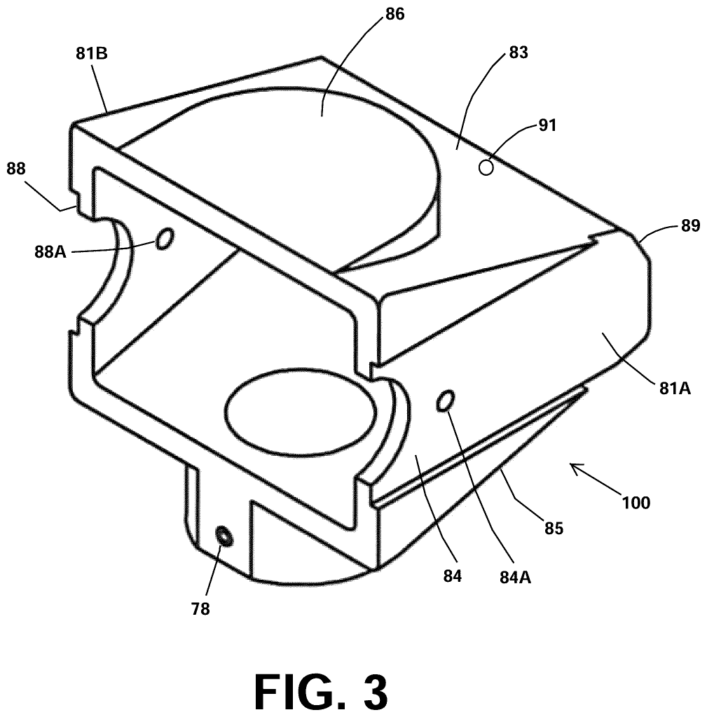

As shown in FIG. 3, the hood assembly 80 (also referred to as a hood, or a frame, or a frame assembly) has a first side wall 81A, a second side wall 81B, a top wall 83, a rear wall 89 and a bottom wall 85. The side walls 81A, 81B are formed opposite to each other. The first side wall 81A has a first machined slot 84 formed therein. A first engagement hole 84A is formed in the first machined slot 84 portion of the first side wall 81A. The second side wall 81B has a second machined slot 88 formed therein. A second engagement hole 88A is formed in the second machined slot 88 portion of the second side wall 81B.

The depth adjustments of the interchangeable guide 100, 120 are made by sliding the guide 100, 120 in the machined slots 84, 88 of the hood 80. The machined slots 84, 88 are configured to receive the end caps 106, 108 (or 126, 128) of the guides 100, 120 in a fixed, desired position so as not to allow twisting of the guides 100, 120.

The top wall 83 has a dome-shaped portion 86 adapted to receive the outside bearing 70 therein. The outside bearing 70 on the spindle (cutter shaft) 20 facilitates a stable operation of the beveling and weld bead removal tool 10. The outside bearing 70 is used on the spindle 20 to make the beveling tool (cutter) more secured and provide rigidity thereby preventing wobble, vibration or cutter chatter to achieve deeper cuts and faster feed rates.

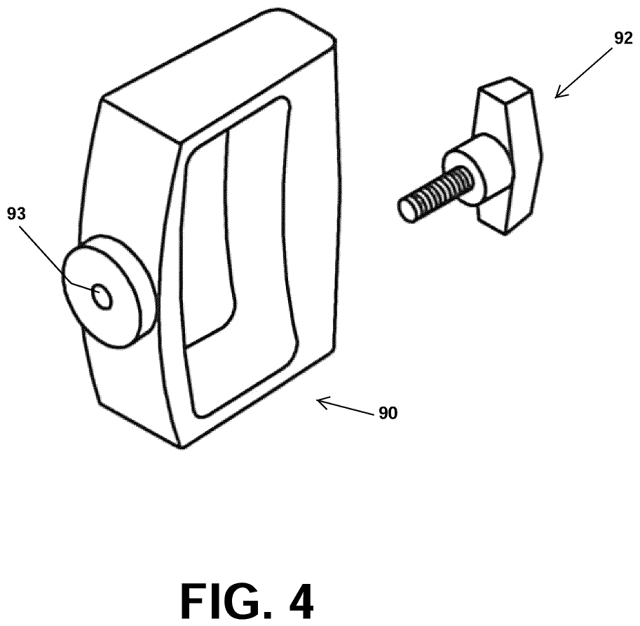

As noted above, the hood 80 has the rear wall 89 having an opening 91 formed therein. The opening is adapted to receive a handle 90 thereon. As shown in FIG. 4, the handle 90 has an opening 93 for securing the handle 90 onto the rear wall 89 by using a bolt 92. The handle 90 may be integrally formed with the hood 80.

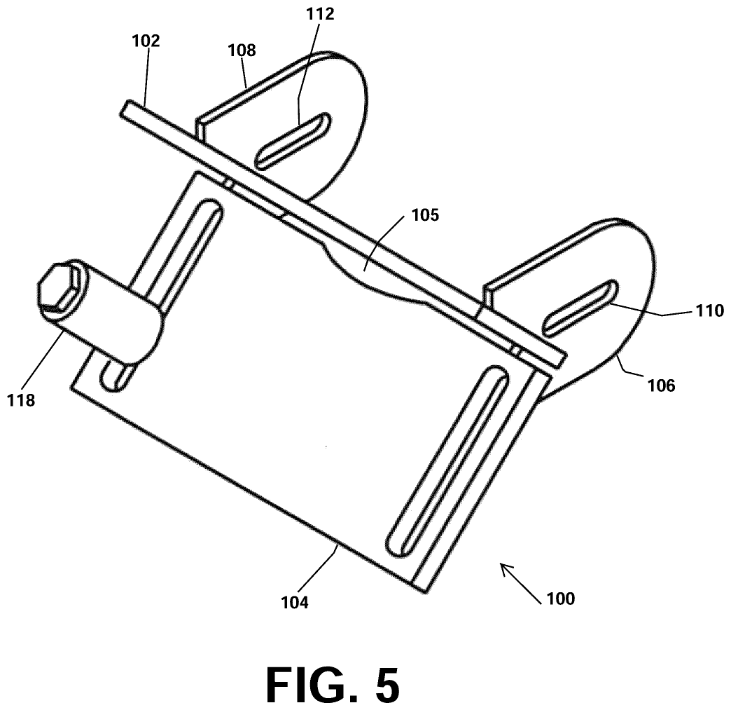

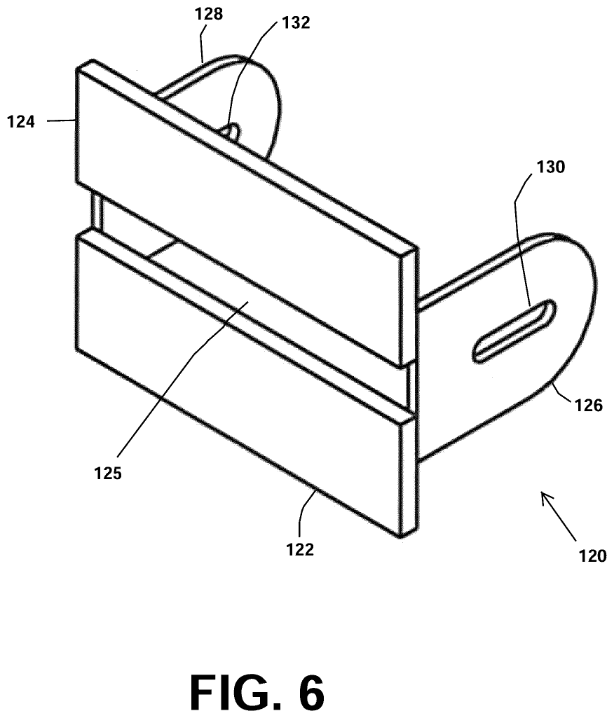

The interchangeable guide (may be referred to as convertible guide) includes a V-block guide 100 (FIG. 5) and a flat guide 120 (FIG. 6). However, guides with shapes such as round shape may be used. The term interchanges means either of the V-block guide 100 or the flat guide 120 can be used depending on the objectives to be achieved.

### V-Block Guide

As shown in FIG. 5, the V-block guide 100 is formed by a pair of plates 102, 104 arranged together side by side at an angle to each other. The angle between the plates 102, 104 is predetermined. The predetermined angle is in a range from 10° to 90°. In other embodiments, the predetermined angle may be more than 90°. Each of the plates 102, 104 has substantially similar thickness, length and width. However, plates 102, 104 may have different thickness, length and width from one another. A pair of end caps 106, 108 is arranged at end portions of the plates 102, 104. The end caps 106, 108 hold the plates 102, 104 at the predetermined angle to each other. The end caps 106, 108 may be welded to the plates 102, 104, or integrally formed with the plates 102, 104. An opening 105 is formed between the pair of plates 102, 104. The opening 105 has a predetermined size and is configured to selectively allow a protrusion of the cutting wheel 40 there through when a depth of the V-block guide 100 is adjusted on the hood 80. Depending on the depth of V-block guide adjusted on the hood 80, the protrusion amount of the cutting wheel 40 changes.

The end caps 106, 108 of the V-block guide 100 include respective elongated holes 110, 112 formed therein. The elongated holes 110, 112 facilitate mounting the V-block guide 100 at various positions for achieving desired depths of cuts by the cutting wheel 40.

The respective hand knobs (bolts) B1, B2 and corresponding washers W1, W2 are used to lock the guide 100, 120 onto the hood 80. When the V-block guide 100 is positioned at a desired depth on the hood 80 by sliding the end caps 106, 108 thereof on the corresponding machined slots 84, 88 formed on the hood 80, the end caps 106, 108 via elongated holes 110, 112 are secured by fastening the respective hand knobs B1, B2 into respective engagement holes 84A, 88A. Respective washers W1, W2 are placed between corresponding end caps 106, 108 and the hand knobs B1, B2. As discussed herein, the flat guide 120 is secured onto the hood 80 is similar manner as to the V-block guide.

The V-block guide optionally includes stops or rollers 118 provided onto one or both the plates 102, 104 of the V-block guide 100. As shown in FIG. 5, a position of the roller 118 can be adjusted on the plate 104.

### Beveling

The beveling operation is performed by using the V-block guide 100 shown in FIG. 5. As noted above, the end caps 106, 108 of the V-block guide 100 include respective elongated holes 110, 112 formed therein.

As noted above, the V-block guide 100 is adjustable up and down to vary the bevel/chamfer depth of cut. The cutting wheel 40 rotates in an axial motion relative to a feed direction which reduces chatter and twist. Operation feed is forward in a conventional mill type direction. The addition of one or more stops or rollers 118 onto one of the plates of the V-block plate 104, pipe or round parts can also be centered for consistent bevels.

### Flat Guide

As shown in FIG. 6, the flat guide 120 is formed by a pair of plates 122, 124 arranged together side by side and parallel to each other. Each of the plates 122, 124 may have a substantially similar thickness. However, the 122, 124 may of different thicknesses. A pair of end caps 126, 128 is arranged at end portion of the plates 122, 124. The end caps 126, 128 hold the plates 122, 124. The end caps 126, 128 may be welded to the plates 122, 124. The end 126, 128 may be integrally formed with the plates 122, 124. An opening 125 is formed between the pair of plates 122, 124. The opening 125 has a predetermined size and is configured to selectively allow a protrusion of the cutting wheel 40 there through when a depth of the cut of the flat guide 120 is adjusted on the hood 80.

The end caps 126, 128 of the flat guide 120 include respective elongated holes 130, 132 formed therein.

The respective hand knobs (bolts) B1, B2 and washers W1, W2 are used to lock the flat guide 120 onto the hood 80. When the flat guide 120 is positioned at a desired depth on the hood 80 by sliding the end caps 126, 128 thereof on the corresponding machined slots 84, 88 formed on the hood 80, the end caps 126, 128 via elongated holes 130, 132 are secured by fastening the respective bolts B1, B2 into respective engagement holes 84A, 88A formed on the hood 80. Respective washers W1, W2 are placed between corresponding end caps 126, 128 and the bolts B1, B2.

### Butt Weld Bead Removal

The flat guide 120 (the weld bead guide) is attached to the hood (frame) 80, and secured onto the hood 80 by bolts B1, B2. Depth of the cut can be adjusted to either leave a little weld bead standing, gouging below the surface of most common flush to the surrounding area.

The cutting wheel 40 turns in an axial rotation in an alignment with the weld bead and feeding forward along the bead which prevents the beveling tool from twisting. Known devices use a face cutter which in contrast would twist the beveling tool (beveling machine) in the operator's hand thereby making the feed choppy and unpredictable. The beveling machine of the present invention makes feed predictable and non-choppy.

### Clad Removal

Replacing one of the plates 122, 124 of a butt weld guide (flat guide) 120 with a different thickness plate, allows creating a milled step in the flat plate. Some flat plates will have a thin “vaneer” plate glued or fixed together. This might be a thin, for example, 1/16″-⅛″ brass or stainless steel attached to thicker mild steel (½″-¾) for strength.

It is desirable to remove the clad always from the edge, for example, ⅜″ to allow the ability to weld sections together.

The beveling and weld bead removal tool 10 discussed herein features the interchangeable guide that makes beveling and weld bead removal operations without the need of additional arrangements. The V-block guide 100 can be easily interchanged with the flat guide 120 and vice versa depending whether beveling or bead removal operation to be performed.

Although the present invention has been described herein with respect to a number of specific illustrative embodiments, the foregoing description is intended to illustrate, rather than to limit the invention. Those skilled in the art will realize that many modifications of the illustrative embodiment could be made which would be operable. All such modifications, which are consistent with, or equivalent to the elements described herein are intended to be within the scope and spirit of the present invention.

What is claimed is:

1. A beveling and weld bead removal tool configured for use with a rotary driver having a drive shaft, said beveling and weld bead removal tool comprising:
a spindle having a first end and a second end, said first end being attachable to the drive shaft;
a cutting wheel mounted on the spindle;
a hood configured to receive the cutting wheel therein; and
a guide adjustably attached to the hood,
wherein a depth of a cut is adjusted by selectively positioning and securing the guide on the hood in a direction substantially transverse to an axis of the spindle.

2. A beveling and weld bead removal tool according to claim 1, further comprising an outside support bearing provided on the second end of the spindle,
wherein said outside support bearing is housed within the hood.

3. The beveling and weld bead removal tool according to claim 1, wherein the guide comprises
a pair of plates arranged together side by side; and
an end cap arranged at each end portion of the pair of plates,
wherein an opening is formed between the pair of plates, said opening configured to selectively allow a protrusion of the cutting wheel.

4. The beveling and weld bead removal tool according to claim 3, wherein:
the hood has a first side wall and a second side wall, each having a machined slot formed therein, the machined slots being configured to receive corresponding end caps of the guide for positioning guide on the hood.

5. The beveling and weld bead removal tool according claim 4, wherein said machined slot has an engagement hole formed therein; and each of the end caps has an elongated slot formed therein, and
wherein the guide is secured at a selective position on the hood by a hand knob placed in the corresponding elongated slot of the end caps and the engagement hole of the machined slots.

6. A beveling and weld bead removal tool according to claim 3, wherein the plates are arranged parallel to each other thereby forming a flat guide.

7. A beveling and weld bead removal tool according to claim 3, wherein the plates are arranged at an angle to each other thereby forming a V-block guide.

8. A beveling and weld bead removal tool according to claim 7, further comprising a pipe roller mounted on one of pair of plates.

9. A beveling and weld bead removal tool according to claim 8, said one of the plates has an elongated opening formed therein and the pipe roller is adjustably received in the elongated opening.

10. A beveling and weld bead removal tool configured for use with a rotary driver having a drive shaft, said beveling and weld bead removal tool comprising:
a spindle having a first end and a second end, said first end being attachable to the drive shaft;
a cutting wheel mounted on the spindle;
a hood configured to receive the cutting wheel therein, said hood having a machined slot formed thereon; and
an interchangeable guide having an end cap,
wherein a depth of a cut is adjusted by selectively positioning and securing the end cap on the machined slot in a direction substantially transverse to an axis of the spindle.

11. A beveling and weld bead removal tool according to claim 10, further comprising an outside support bearing provided on the second end of the spindle,
wherein said outside support bearing is housed within the hood.

12. The beveling and weld bead removal tool according to claim 10, wherein the interchangeable guide includes a flat guide comprising a pair of plates arranged together side by side and parallel to each other, said pair of plates forming an opening therebetween.

13. The beveling and weld bead removal tool according to claim 10, wherein the interchangeable guide includes a V-block guide comprising a pair of plates arranged together side by side and at an angle to each other, said pair of plates forming an opening therebetween.

14. A beveling and weld bead removal tool according to claim 13, further comprising a pipe roller mounted on one of pair of plates, said one of the plates having an elongated opening formed therein, said elongated opening configured to adjustably receive the pipe roller therein.

15. A beveling and weld bead removal machine comprising
a rotary driver having a drive shaft;
a spindle attached the drive shaft;
a cutting wheel mounted on the spindle;
a hood configured to receive the cutting wheel therein; and
an interchangeable guide selectively positioned on the hood.

16. The A beveling and weld bead removal machine according to claim 15, further comprising a support bearing provided a portion of the spindle housed within the hood.

17. The beveling and weld bead removal machine according to claim 15, wherein the interchangeable guide includes a flat guide comprising a pair of plates arranged together side by side and parallel to each other, and a pair of end caps attached to the pair of plates.

18. The beveling and weld bead removal machine according to claim 17, wherein the pair of plates comprises a first plate and a second plate, and a thickness of first plate is more than a thickness of the second plate.

19. The beveling and weld bead removal tool according to claim 15, wherein the interchangeable guide includes a V-block guide comprising a pair of plates arranged together side by side and at an angle to each other, and a pair of end caps attached to the pair of plates.

20. A beveling and weld bead removal tool according to claim 19, further comprising a pipe roller mounted on one of pair of plates, said one of the plates having an elongated opening formed therein, said elongated opening configured to adjustably receive the pipe roller therein.
